(19) United States
(12) Patent Application Publication
(10) Pub. No.: US 2012/0141138 A1
(43) Pub. Date: Jun. 7, 2012

(54) System, Devices and Methods for Subcarrier Recovery at Local Oscillator Frequency in Optical OFDM System

(75) Inventors: Qi YANG, Wuhan City (CN); Zhixue HE, Wuhan City (CN); Wu LIU, Wuhan City (CN); William SHIEH, Victoria (AU); Ivan B. DJORDJEVIC, Tucson, AZ (US); Zhu YANG, Wuhan City (CN); Shaohua YU, Wuhan City (CN)

(73) Assignee: Wuhan Research Institute of Posts and Telecommunications, Wuhan City (CN)

(21) Appl. No.: 12/959,874

(22) Filed: Dec. 3, 2010

(51) Int. Cl. H04B 10/02; H04B 10/00

(52) U.S. Cl. 398/158; 398/140

(57) ABSTRACT

The invention provides methods, devices and a system for recovering the corrupted subcarrier at the local oscillator (LO) frequency in coherent optical OFDM transmission. The method includes performing advanced coding on a data signal to obtain an encoded signal; performing high order modulation on the encoded signal to obtain a high-order-modulated signal; performing OFDM modulation on the high-order-modulated signal to obtain an electrical OFDM signal; and performing up-conversion on the electrical OFDM signal to obtain an optical OFDM signal to be output. The inventive technique of employing advanced coding with low rate combining with higher order modulation can be used to reduce the decoding bit error ratio (bit error rate) level, so that the LO subcarrier can be fully recovered while the bandwidth of the transmitted signal may be substantially the same as the existing optical OFDM system, and there is no need to add any feedback control module or feedback loop support or the like to the existing optical OFDM system, so that the complexity of the receiving side can be reduced.

### CROSS REFERENCE TO RELATED APPLICATIONS

This application relates to a concurrently filed, co-pending, and commonly assigned U.S. patent application Ser. No. 12/959,689, entitled “Optical Communication System, Device and Method Employing Advanced Coding and High Order Modulation” by Qi Yang et al., the disclosure of which is hereby incorporated by reference herein in its entirety.

### FIELD OF THE INVENTION

The present invention relates to devices and methods for converting a data signal into an optical signal and converting an optical signal into a data signal, and a system for communicating an optical signal, and more particularly, relates to methods, devices and a system for recovering a signal at local oscillator frequency, which may be corrupted due to nonlinear effects.

### DESCRIPTION OF RELATED ART

Orthogonal frequency-division multiplexing (OFDM) is widely studied by optical communication communities in recent years. The publications on optical OFDM have grown dramatically since the optical OFDM was proposed as an attractive modulation format for long-haul transmission either in coherent detection or direct-detection several years ago. Net transmission data rates grew at a speed of 10 times per year at an experimental level. To date, the experimental demonstration of up to 1 Tb/s transmission in a single channel has been provided, while the demonstrative speed of real-time optical OFDM with digital signal processing has exceeded 10-Gb/s. These developments may eventually lead to commercial transmission products based on optical OFDM in the future, with the potential benefits of high spectral efficiency and flexible network design.

In an OFDM communication system, a signal is transmitted by multiple orthogonal subcarriers. Each subcarrier carries a portion of transmitted data. For example, in a coherent optical OFDM (CO-OFDM) system, a local oscillator (LO) is used to beat with the signal in an optical hybrid at a receiving side. A subcarrier where the local oscillator is located (i.e., the LO subcarrier) may be corrupted due to the receiver nonlinear effects. In a conventional coherent optical OFDM (CO-OFDM) system, in which DFT window size is below 512, which is a common used value, one subcarrier usually carries more than about 0.2% of the whole data rate. If the LO subcarrier is corrupted, the bit error ratio (BER) is at least more than about 2×10⁻³. Some conventional Forward Error Correction (FEC) techniques, such as Reed Solomon (RS) (255, 239), only recover a signal with a bit error rate of about 1×10⁻³. As a result, the LO subcarrier carried information is hard to be recovered, and becomes not useful. For example, prior to current time, the publication of Melbourne university group (i.e., Qi Yang et. at., titled by “107 Gbs Coherent Optical OFDM Reception Using Orthogonal Band Multiplexing”, “1-Tbs per Channel Coherent Optical OFDM Transmission with Subwavelength Bandwidth Access”, etc) has shown several experimental demonstrations for CO-OFDM transmission, including 100-Gb/s and 1-Tb/s over 1000-km standard single mode fiber (SSMF). In all their demonstrations, a few subcarriers in the middle of all subcarriers have to be filled with null. And the local oscillator frequency is finely adjusted inside those un-filled subcarriers, so that no used subcarrier is affected by the LO. However, in reality, the optical receiver is placed far away from the transmitter. The frequency locations of the transmitted subcarriers are unknown to the receiver. Thus, the LO subcarrier may be easily corrupted. As a result, the subcarrier information will be lost. In order to conveniently fill the payload of the subcarrier at the transmitting side and take advantage of all the subcarriers, the location of the local oscillator has to be controlled. A feedback control module is necessary to lock the frequency of LO close to the signal laser. A conventional solution provides a coherent optical receiver with electrical compensation/equalization that shows a complete coherent optical system with feedback-control function. This increases the complexity of the coherent receiver structure.

### SUMMARY OF THE INVENTION

The present invention describes a system, devices, and methods for realizing the LO subcarrier recovery without the feedback loop support in the optical OFDM system, thereby reducing the complexity of the receiver structure. In one embodiment of the invention, methods, devices and a system are provided that effectively recover the LO carrier information without modifying the existing optical OFDM system. The invention combines advanced coding scheme with high order modulation to improve the sensitivity of the receiver, which advantageously doe not require further modification to the existing optical OFDM system. In the optical OFDM system, it is desirable to effectively recover the corrupted information on LO subcarrier.

In one embodiment of the invention, a method is provided for converting a data signal into an optical OFDM signal, comprising performing advanced coding on a data signal to obtain an encoded signal; performing high order modulation on the encoded signal to obtain a high-order-modulated signal; performing OFDM modulation on the high-order-modulated signal to obtain an electrical OFDM signal; and performing up-conversion on the electrical OFDM signal to obtain an optical OFDM signal to be output.

In one embodiment of the invention, the advanced coding has a coding gain above 7 dB at a bit error rate of 10⁻¹³ compared to BER-versus-OSNR(Optical Signal Noise Ratio) performance of un-coded transmission.

In one embodiment of the invention, the advanced coding has a code rate of 20%˜75%.

In one embodiment of the invention, the advanced coding includes one of Low-density parity-check coding, and Turbo coding.

In one embodiment of the invention, the high order modulation uses M-ray phase shift keying (M-PSK) or M-ray quadrature amplitude modulation (M-QAM), M≧8.

In one embodiment of the invention, the method further comprises: before the advanced coding step, which can be considered as inner encoding by an inner encoder, encoding input bits which can be considered as outer encoding by an outer encoder; and interleaving the encoded bits to obtain the data signal on which the advanced coding is to be performed. According to another example of the invention, the electrical OFDM signal comprises a plurality of subcarriers.

In one embodiment of the invention, a method is provided for converting an optical OFDM signal on which advanced coding, high order modulation, OFDM modulation, and up-conversion were performed, into a data signal, the method comprising the steps of: performing down-conversion on the optical OFDM signal to obtain an electrical OFDM signal; performing OFDM demodulation on the electrical OFDM signal; performing high order demodulation on the OFDM-demodulated signal; and performing advanced decoding on the high-order-demodulated signal to obtain a data signal.

In one embodiment of the invention, the advanced coding has a coding gain above 7 dB at a bit error rate of 10⁻¹³ compared to BER-versus-OSNR performance of un-coded transmission.

In one embodiment of the invention, the advanced coding has a code rate of 20%˜75%.

In one embodiment of the invention, the advanced coding includes one of Low-density parity-check coding, and Turbo coding.

In one embodiment of the invention, the high order modulation uses M-ray phase shift keying (M-PSK) or M-ray quadrature amplitude modulation (M-QAM), M≧8.

In one embodiment of the invention, the method further comprises the steps of: after the advanced decoding step, which can be considered as inner decoding by an inner decoder: de-interleaving the decoded signal; and decoding the de-interleaved signal, which can be considered as outer decoding by an outer decoder.

In one embodiment of the invention, the electrical OFDM signal comprises a plurality of subcarriers.

In one embodiment of the invention, a converter is provided for converting a data signal into an optical OFDM signal, comprising an advanced encoder for performing advanced coding on a data signal to obtain an encoded signal; a high order modulator for performing high order modulation on the encoded signal to obtain a high-order-modulated signal; an OFDM modulator for performing OFDM modulation on the high-order-modulated signal to obtain an electrical OFDM signal; and an up-converter for performing up-conversion on the electrical OFDM signal to obtain an optical OFDM signal to be output.

In one embodiment of the invention, a converter is provided for converting an optical OFDM signal on which advanced coding, high order modulation, OFDM modulation, and up-conversion were performed, into a data signal, the converter comprising: an down-converter for performing down-conversion on the optical OFDM signal to obtain an electrical OFDM signal; an OFDM demodulator for performing OFDM demodulation on the electrical OFDM signal; a high order demodulator for performing high order demodulation on the OFDM-demodulated signal; and an advanced decoder for performing advanced decoding on the high-order-de-modulated signal to obtain a data signal.

In one embodiment of the invention, a transmitting device is provided for transmitting an optical OFDM signal, comprising: an advanced encoder for performing advanced coding on a data signal to obtain an encoded signal; a high order modulator for performing high order modulation on the encoded signal to obtain a high-order-modulated signal; an OFDM modulator for performing OFDM modulation on the high-order-modulated signal to obtain an electrical OFDM signal; an up-converter for performing up-conversion on the electrical OFDM signal to obtain an optical OFDM signal to be output; and a transmitting unit for transmitting the optical OFDM signal.

In one embodiment of the invention, a receiving device is provided for receiving an optical OFDM signal on which advanced coding, high order modulation, OFDM modulation, and up-conversion were performed, the receiving device comprising: a receiving unit for receiving the optical OFDM signal; an down-converter for performing down-conversion on the optical OFDM signal to obtain an electrical OFDM signal; an OFDM demodulator for performing OFDM demodulation on the electrical OFDM signal; a high order demodulator for performing high order demodulation on the OFDM-demodulated signal; and an advanced decoder for performing advanced decoding on the high-order-de-modulated signal to obtain a data signal.

In one embodiment of the invention, an optical communication system comprises an advanced encoder for performing advanced coding on a data signal to obtain an encoded signal; a high order modulator for performing high order modulation on the encoded signal to obtain a high-order-modulated signal; an OFDM modulator for performing OFDM modulation on the high-order-modulated signal to obtain an electrical OFDM signal; an up-converter for performing up-conversion on the electrical OFDM signal to obtain an optical OFDM signal; a transmitting unit for transmitting the optical OFDM signal; a receiving unit for receiving the optical OFDM signal; an down-converter for performing down-conversion on the optical OFDM signal to obtain the electrical OFDM signal; an OFDM demodulator for performing OFDM demodulation on the electrical OFDM signal; a high order demodulator for performing high order demodulation on the OFDM-demodulated signal; and an advanced decoder for performing advanced decoding on the high-order-de-modulated signal to obtain a data signal.

For example, an exemplary method may include generating encoded signal from the original data using advanced error correction codes (ECCs) technique in an existing CO-OFDM communication system. Then the encoded signal will be modulated onto higher order modulation compared to the original used format. No modification is added into the existing CO-OFDM system. And the encoded signal subjected to higher order modulation may have the same bandwidth as the original used scheme. When receiving the transmitted signal, the exemplary method also includes de-modulating the signal from the higher order modulations, then decoding the signal using the corresponding decoding scheme. The exemplary method may further use interleaver/de-interleaver, and outer encoder/decoder. The interleaver/de-interleaver is used to avoid the burst error, while the outer encoder/decoder is used to eliminate the potential error floor.

Thus, with the embodiments of the invention, the corrupted LO subcarrier information can be fully recovered, while the bandwidth of the transmitted signal may be substantially the same as the existing optical OFDM system, and there is no need to add any feedback control module or feedback loop support or the like to the existing optical OFDM system, so that the complexity of the receiving side can be reduced.

The structures and methods of the present invention are disclosed in the detailed description below. This summary does not purport to define the invention. The invention is defined by the claims. These and other embodiments, features, aspects, and advantages of the invention will become better understood with regard to the following description, appended claims and accompanying drawings.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a system diagram illustrating an exemplary coherent optical OFDM communication system in accordance with the present invention.

FIG. 2 is a block diagram illustrating a converter configuration for converting a data signal into an optical OFDM signal according to an embodiment of the invention.

FIG. 3 is a block diagram illustrating a converter configuration for converting an optical OFDM signal into a data signal according to another embodiment of the invention.

FIG. 4 is a block diagram illustrating a configuration of an optical communication system for communicating the optical OFDM signal according to further embodiment of the invention.

FIG. 5 is a flowchart for describing the flow of a method for converting a data signal into an optical OFDM signal according to an embodiment of the invention.

FIG. 6 is a flowchart illustrating a method for converting an optical OFDM signal into a data signal according to another embodiment of the invention.

FIG. 7A is a block diagram illustrating an experimental system configuration of 1.08-Tb/s coherent optical OFDM over 1040-km transmission.

FIG. 7B is a graphical diagram illustrating the performances of a conventional system and the system as shown in FIG. 7A.

### DETAILED DESCRIPTION

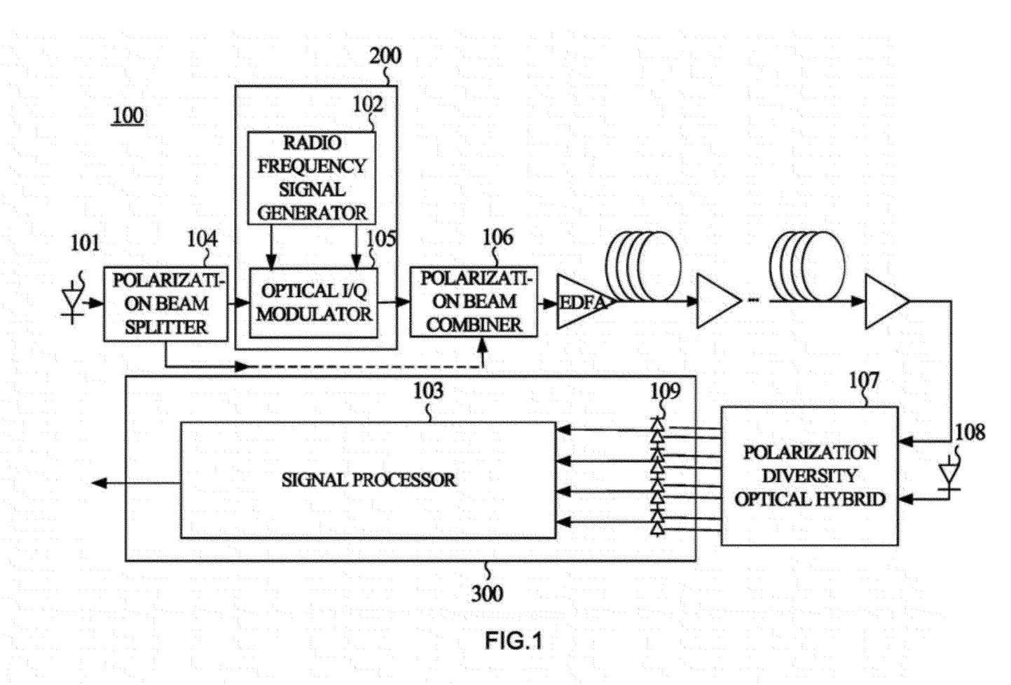

A description of structural embodiments and methods of the present invention is provided with reference to FIGS. 1-7. It is to be understood that there is no intention to limit the invention to the specifically disclosed embodiments but that the invention may be practiced using other features, elements, methods and embodiments. Like elements in various embodiments are commonly referred to with like reference numerals. Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

FIG. 1 is a schematic diagram of an exemplary coherent optical OFDM communication system. As shown in FIG. 1, in the coherent optical OFDM communication system 100, at the transmitting side, a signal laser 101 is first split into two branches with even power using an optical polarization-beam splitter (PBS) 104. Each branch is used to carry one polarization data. A Radio Frequency (RF) OFDM signal is produced from a data signal by a Radio Frequency (RF) signal generator 102. Then the RF OFDM signal is up-converted onto optical domain using an optical I/Q modulator 105 to obtain an optical OFDM signal. The two branches are combined by a polarization-beam combiner (PBC) 106. Then the optical OFDM signal is transmitted through fiber links. Erbium-doped fiber amplifers (EDFAs) are used to compensate the fiber span loss. At the receiving side, a Local Oscillator (LO) 108 beats the received optical OFDM signal in a polarization-diversity optical hybrid 107. Then the optical OFDM signal is down-converted into RF domain using four pairs of balanced photo-diodes 109 to obtain an RF OFDM signal. The RF OFDM signal is sampled by four high speed ADCs (not shown) in an RF signal processor 103, and finally is processed in the signal processor 103 to obtain a data signal.

Substantially, the optical OFDM communication system can be divided into three primary parts, a transmitting device including a converter 200 (to be described below) for converting a data signal into an optical OFDM signal (including the RF signal generator 102 and the optical I/Q modulator 105 and so on in the example), a transmitting unit, an optical channel (such as the fiber links in the example), and a receiving device including a receiving unit and a converter 300 (to be described below) for converting an optical OFDM signal into a data signal (including the four pairs of balanced photo-diodes 109, and the signal processor 103 and so on in the example). The configuration of the coherent optical OFDM communication system shown in FIG. 1 is only an example, but the invention is not limited to this.

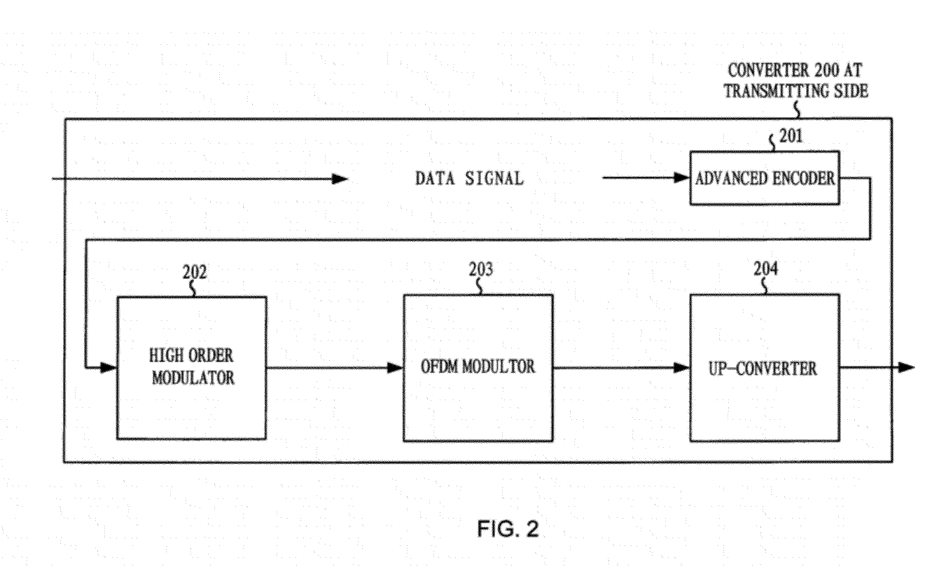

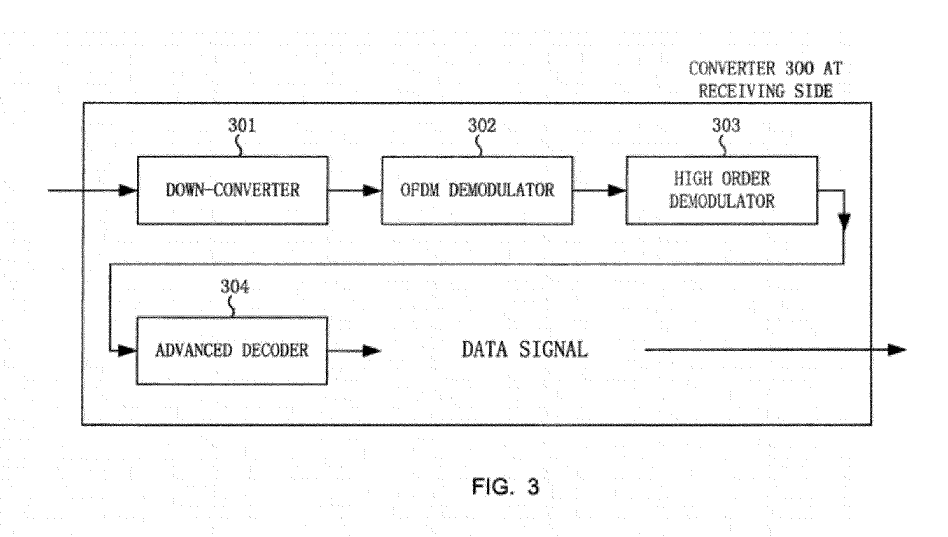

Now with reference to FIG. 2 and FIG. 3, the converter 200 for converting a data signal into an optical OFDM signal at the transmitting side and the converter 300 for converting an optical OFDM signal into a data signal at the receiving side will be described in detail.

FIG. 2 is a schematic diagram for describing the configuration of a converter 200 for converting a data signal into an optical OFDM signal according to an embodiment of the invention. As shown in FIG. 2, the converter 200 for converting a data signal into an optical OFDM signal, comprises: an advanced encoder 201 for performing advanced coding on a data signal to obtain an encoded signal; a high order modulator 202 for performing high order modulation on the encoded signal to obtain a high-order-modulated signal; an OFDM modulator 203 for performing OFDM modulation on the high-order-modulated signal to obtain an electrical OFDM signal; and an up-converter 204 for performing up-conversion on the electrical OFDM signal to obtain an optical OFDM signal to be output.

In one embodiment of the invention, the advanced encoder 201, the high order modulator 202, the OFDM modulator 203 in FIG. 2 can compose the Radio Frequency signal generator 102 in FIG. 1. The up-converter 204 in FIG. 2 can correspond to the optical I/Q modulator 105 in FIG. 1. However, the invention is not limited to this.

In one embodiment of the invention, the advanced encoder 201 may have a coding gain above 7 dB at a bit error rate of 10⁻¹³ compared to BER-versus-OSNR performance of un-coded transmission. In one embodiment of the invention, the advanced encoder 201 may have a code rate R of 20%˜75%. For example, the advanced encoder 201 may use a strong error correction code, such as Low-density parity-check (LDPC) code, Turbo code, trellis coded modulation and so on. However, the invention is not limited to this, and other advanced coding methods which are existing or to be developed in the future can be applied to this invention.

In one embodiment of the invention, the high order modulator 202 may use M-ray phase shift keying (M-PSK) or M-ray quadrature amplitude modulation (M-QAM), M≧8, but the high order modulation of the invention is not limited to this, and other high order modulation which is existing or to be developed in the future can be applied to the invention.

When the converter 200 operates, input electrical bits are encoded by the advanced encoder 201, and modulated by the high order modulator 202. Due to the high order modulator 202, although the Error Correction Code (ECC) rate of the advanced encoder 201 is low, the spectrum efficiency may still maintain at least in a conventional level in which the spectrum efficiency is greater than 2.5 bit/s/Hz, for example. Assuming the original modulation order of the conventional CO-OFDM system is M′ (M′<M). The transmitted signal bandwidth can maintain the same when

log₂(M′)=log₂(M)×R

R is the coding rate of the advanced encoder. And the conventional CO-OFDM system configuration may be not substantially changed, and no feedback control module or feedback loop support is needed. Such relationship in this invention is not limited to this.

Then, for example, the electrical OFDM signal may be generated by using a OFDM modulator 203 (whether conventional or modified), and the analog RF OFDM signal may be produced and exported by high speed digital-to-analog converters (DACs) (not shown) in the OFDM modulator 203, in which the electrical OFDM signal comprises a plurality of subcarriers.

Then, the generated RF OFDM signal is up-converted by the up-converter 204 to obtain an optical OFDM signal to be transmitted through the fiber links

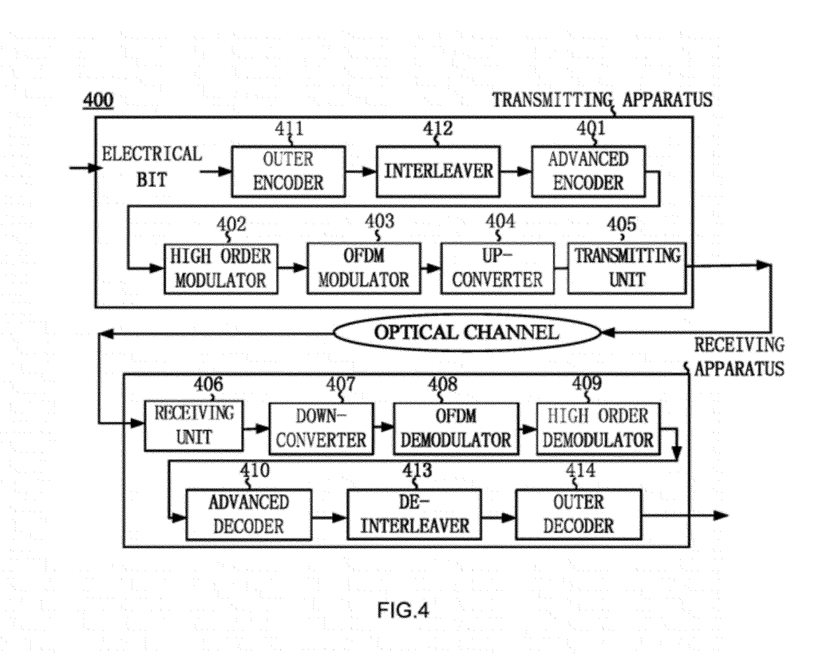

In one embodiment of the invention, in addition to the above configuration, in order to realize a better error correction performance, the converter 200 may further comprise: an outer encoder for encoding input bits; and an interleaver for interleaving the encoded bits to obtain the data signal on which the advanced coding is to be performed by the advanced encoder 201. (In some cases, the advanced encoder/coding may be referred to as an inner encoder/coding.) The configuration and the function of the outer encoder and the interleaver will be described in an optical communication system with reference to FIG. 4.

Referring now to FIG. 3, FIG. 3 is a schematic diagram for describing the configuration of a converter 300 for converting an optical OFDM signal into a data signal at the receiving side according to another embodiment of the invention.

As shown in FIG. 3, the converter 300 includes: an down-converter 301 for performing down-conversion on the optical OFDM signal to obtain an electrical OFDM signal; an OFDM demodulator 302 for performing OFDM demodulation on the electrical OFDM signal; a high order demodulator 303 for performing high order demodulation on the OFDM-demodulated signal; and an advanced decoder 304 for performing advanced decoding on the high-order-de-modulated signal to obtain a data signal.

For example, the down-converter 301 in FIG. 3 may correspond to the four pairs of balanced photo-diodes 109 in FIG. 1 to down-convert the received optical OFDM signal to obtain an electrical OFDM signal. And the OFDM demodulator 302, high order demodulator 303, and the advanced decoder 304 in FIG. 3 may compose the signal processor 103 in FIG. 1. However, the invention is not limited to this.

As described above, the received optical OFDM signal corresponds to the transmitted optical OFDM signal on which advanced coding, high order modulation, OFDM modulation, and up-conversion were performed. Of course, Due to non-linear effects, the received optical OFDM signal at LO frequency may be corrupted.

The down-converter 301 down-converts the received optical OFDM signal to obtain an electrical OFDM signal. The electrical OFDM signal comprises a plurality of subcarriers.

The OFDM demodulator 302 is used to demodulate the electrical OFDM signal with CO-OFDM detection scheme, for example, to obtain an OFDM-demodulated signal. The OFDM demodulator 302 may include high speed ADCs (not shown), which are used to sample the high speed analog OFDM signal to obtain a digital OFDM signal. The OFDM demodulator 302 may perform several Digital Signal Processing (DSP) procedures, such as frequency offset estimation, channel estimation, phase noise estimation, etc on the digital OFDM signal.

The OFDM-demodulated signal is demodulated by the high order demodulator 303. As mentioned above, the high order modulator 202 at the transmitting side may use M-ray phase shift keying (M-PSK) or M-ray quadrature amplitude modulation (M-QAM), M≧8, but the high order modulation of the invention is not limited to this, and other high order modulations which are existing or to be developed in the future can be applied to the invention. Thus, at the receiving side, the high order demodulator 303 corresponds to the high order modulator 202 at the transmitting side. The high order demodulator 303 is used to detect the signal from the constructed constellations from the OFDM demodulator 302. If the binary bit is decided in this part, then the inner hard-decision scheme is used in the advanced decoder 304. If the likelihood is sent, then the advanced decoder 304 will use soft-decision scheme, which has further improvement compared to hard-decision scheme.

The high-order-demodulated signal is decoded by the advanced decoder 304. As mentioned above, at the transmitting side, the advanced encoder 201 may have a coding gain above 7 dB at a bit error rate of 10⁻¹³ compared to BER-versus-OSNR performance of un-coded transmission. In one embodiment of the invention, the advanced encoder 201 may have a code rate R of 20%˜75%. For example, the advanced encoder 201 may use a strong error correction code, such as low-density parity-check code, Turbo code, and so on, but the invention is not limited to this, and other advanced coding methods which are existing or to be developed in the future can be applied to this invention. The advanced decoder 304 at the receiving side corresponds to the advanced encoder 201 at the transmitting side. Thus, the advanced decoder 304 recovers the signal using the same rate decoding scheme corresponding to the advanced coding scheme. For instance, if the LDPC coding scheme is used in the advanced encoder 201, several corresponding LDPC decoding algorithms can be employed, as such log-domain sum-product algorithm.

According to one example of the invention, if at the transmitting side, prior to the operations of the advanced encoder 201, high order modulator 202 and so on, the signal was interleaved and encoded by an interleaver and an outer encoder, the converter 300 at the receiving side may further comprise: a de-interleaver for de-interleaving the data signal; and an outer decoder for decoding the de-interleaved signal. (In some cases, the advanced decoder/decoding may be referred to an inner decoder/decoding.) The configurations and functions of the de-interleaver and the outer decoder will be described in detail with reference to FIG. 4.

Thus, according to the invention, the corrupted LO subcarrier information can be fully recovered, while the bandwidth of the transmitted signal may be substantially the same as the existing optical OFDM system, and there is no need to add any feedback control module or feedback loop support or the like to the existing optical OFDM system, so that the complexity of the receiving side can be reduced.

Referring now to FIG. 4, FIG. 4 is a schematic diagram for describing the configuration of an optical communication system for communicating the optical OFDM signal according to another embodiment of the invention.

As shown in FIG. 4, an optical communication system 400 comprises: an advanced encoder 401 for performing advanced coding on a data signal to obtain an encoded signal; a high order modulator 402 for performing high order modulation on the encoded signal to obtain a high-order-modulated signal; an OFDM modulator 403 for performing OFDM modulation on the high-order-modulated signal to obtain an electrical OFDM signal; an up-converter 404 for performing up-conversion on the electrical OFDM signal to obtain an optical OFDM signal; a transmitting unit 405 for transmitting the optical OFDM signal; a receiving unit 406 for receiving the optical OFDM signal; an down-converter 407 for performing down-conversion on the optical OFDM signal to obtain the electrical OFDM signal; an OFDM demodulator 408 for performing OFDM demodulation on the electrical OFDM signal; a high order demodulator 409 for performing high order demodulation on the OFDM-demodulated signal; and an advanced decoder 410 for performing advanced decoding on the high-order-de-modulated signal to obtain a data signal.

The configurations and the functions of the advanced encoder 401, the high order modulator 402, the OFDM modulator 403, the up-converter 404, the down-converter 407, the OFDM demodulator 408, the high order demodulator 409 and the advanced decoder 410 are similar to the advanced encoder 201, high order modulator 202, the OFDM modulator 203, the up-converter 204, the down-converter 301, the OFDM demodulator 302, the high order demodulator 303 and the advanced decoder 304 as described above, details omitted. The transmitting unit 405 and the receiving unit 406 are known in the related art, details omitted.

In order to realize a better error correction performance, the optical communication system 400 may further comprise an outer encoder 411 for encoding input bits; an interleaver 412 for interleaving the encoded bits to obtain the data signal on which advanced coding is to be performed by the advanced encoder 401; a de-interleaver 413 for de-interleaving the decoded signal by the advanced decoder 410; and an outer decoder 414 for decoding the de-interleaved signal.

In this case, electrical bits are first encoded by the outer encoder 411. Such outer encoder 411 is used to eliminate the potential error floor. For instance, an RS (239,255) encoding scheme can be used here to correct the random distributed error with bit error ratio (bit error rate) below about 2×10⁻³. The interleaver 412 is employed to avoid the effects of burst error.

At the receiving side, the de-interleaver 413 re-constructs the bits according to the interleaver 412 at the transmitter side, which is used to eliminate the burst errors. The outer decoder 414 recovers the signal using the corresponding outer decoding scheme corresponding to the outer encoder 411. Some decoding algorithms can be employed here. For instance, among various LDPC coding schemes, log-domain sum-product algorithm is one of the most widely used decoding schemes.

Thus, according to the invention, the corrupted LO subcarrier information can be fully recovered, while the bandwidth of the transmitted signal may be substantially the same as the existing optical OFDM system, and there is no need to add any feedback control module or feedback loop support or the like to the existing optical OFDM system, so that the complexity of the receiving side can be reduced.

As shown in FIG. 4, if the optical communication system is divided into a transmitting device and a receiving device, FIG. 4 also provides a transmitting device for transmitting an optical OFDM signal in an optical communication system, comprising: an advanced encoder 401 for performing advanced coding on a data signal to obtain an encoded signal; a high order modulator 402 for performing high order modulation on the encoded signal to obtain a high-order-modulated signal; an OFDM modulator 403 for performing OFDM modulation on the high-order-modulated signal to obtain an electrical OFDM signal; an up-converter 404 for performing up-conversion on the electrical OFDM signal to obtain an optical OFDM signal to be output; and a transmitting unit 405 for transmitting the optical OFDM signal.

FIG. 4 also provides a receiving device for receiving an optical OFDM signal on which advanced coding, high order modulation, OFDM modulation, and up-conversion were performed, the receiving device comprising: a receiving unit 406 for receiving the optical OFDM signal; an down-converter 407 for performing down-conversion on the optical OFDM signal to obtain an electrical OFDM signal; an OFDM demodulator 408 for performing OFDM demodulation on the electrical OFDM signal; a high order demodulator 409 for performing high order demodulation on the OFDM-demodulated signal; and an advanced decoder 410 for performing advanced decoding on the high-order-de-modulated signal to obtain a data signal.

Certainly, the transmitting device and the receiving device may include same configuration as mentioned above as converters 200 and 300 respectively, but they may include other devices not shown and described here to perform better recovery performance of the signal.

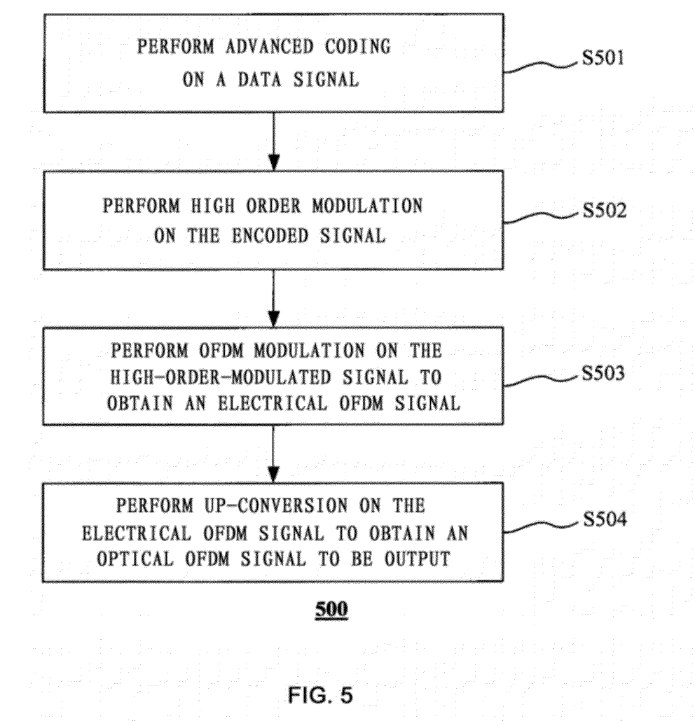

Referring now to FIG. 5, FIG. 5 is a flowchart for describing the flow of a method 500 for converting a data signal into an optical OFDM signal at transmitting side according to another embodiment of the invention.

As shown in FIG. 5, the method 500 for converting a data signal into an optical OFDM signal includes: performing advanced coding on a data signal to obtain an encoded signal (S501), for example, by the advanced encoder 201 in FIG. 2; performing high order modulation on the encoded signal to obtain a high-order-modulated signal (S502), for example, by the high order modulator 202 in FIG. 2; performing OFDM modulation on the high-order-modulated signal to obtain an electrical OFDM signal (S503), for example, by the OFDM modulator 203 in FIG. 2; and performing up-conversion on the electrical OFDM signal to obtain an optical OFDM signal to be output (S504), for example, by the up-converter 204 in FIG. 2.

When generating the optical OFDM signal at the transmitter side, the binary payload is first encoded with the advanced coding step at step 501. The output of the step 501 is also binary format. According to one example of the invention, the advanced coding has a coding gain above 7 dB at a bit error rate of 10⁻¹³ compared to BER-versus-OSNR performance of un-coded transmission. According to another example of the invention, the advanced coding has a code rate R of 20%˜75%. The advanced coding may use a strong error correction code, such as low-density parity-check code, Turbo code, and so on, but the invention is not limited to this, and other advanced coding methods which are existing or to be developed in the future can be applied to this invention.

Then the encoded bits will be modulated onto high order modulations at step 502. According to another example of the invention, the high order modulation uses M-ray phase shift keying (M-PSK) or M-ray quadrature amplitude modulation (M-QAM), M≧8, but the high order modulation of the invention is not limited to this, and other high order modulation which is existing or to be developed in the future can be applied to the invention.

Thus, due to the high order modulation, although the Error Correction Code (ECC) rate of the advanced coding is low, the spectrum efficiency still maintains at least in a conventional level. Assuming the original modulation order of the conventional CO-OFDM system is M′ (M′<M). The transmitted signal bandwidth can maintain the same when log₂(M′)=log₂(M)×R. And the CO-OFDM system configuration may be not substantially changed.

Then the signal will be converted into OFDM format at step 503. The OFDM modulation may include serial-to-parallel conversion, inverse discrete Fourier transform (IDFT), etc. The electrical OFDM signal may be generated by two high speed digital-to-analog convertors (DACs) (not shown). The electrical OFDM signal comprises a plurality of orthogonal subcarriers. The OFDM modulation is known in the related art, so details about the OFDM modulation are omitted.

The electrical OFDM signal is up-converted to obtain an optical OFDM signal at step S504, to be output.

According to another example of the invention, the method 500 may further comprise the steps of: before the advanced coding step S501: encoding input bits; and interleaving the encoded bits to obtain the data signal on which the advanced coding is to be performed.

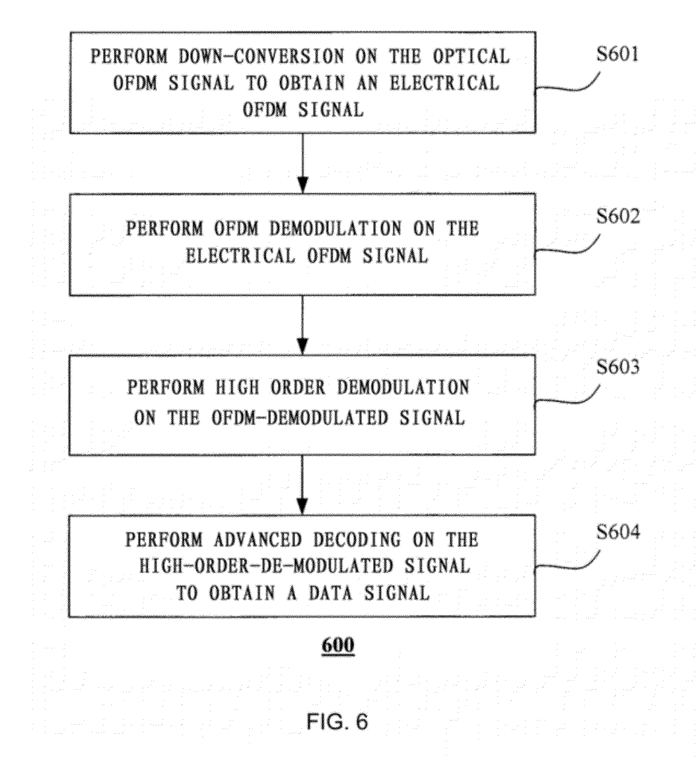

FIG. 6 is a flowchart for describing the flow of a method 600 for converting an optical OFDM signal into a data signal at a receiving side according to another embodiment of the invention. As shown in FIG. 6, the method 600 for converting an optical OFDM signal into a data signal at a receiving side, the method comprising the steps of: performing down-conversion on the optical OFDM signal to obtain an electrical OFDM signal (S601), for example, by the down-converter 301 in FIG. 3; performing OFDM demodulation on the electrical OFDM signal (S602), for example, by the OFDM demodulator 302 in FIG. 3; performing high order demodulation on the OFDM-demodulated signal (S603), for example, by the high order demodulator 303 in FIG. 3; and performing advanced decoding on the high-order-de-modulated signal to obtain a data signal (S604), for example, by the advanced decoder 304 in FIG. 3.

The received optical OFDM signal corresponds to the transmitted optical OFDM signal on which advanced coding, high order modulation, OFDM modulation, and up-conversion were performed.

In particularly, in the step S601, the optical OFDM signal is down-converted to obtain an electrical OFDM signal.

In step S602, the electrical OFDM signal is sampled by four pairs of analog-to-digital converts (ADCs) (not shown) to obtain digital OFDM signal. The electrical OFDM signal comprises a plurality of subcarriers. And then, the digital OFDM signal is OFDM-demodulated. The OFDM demodulation procedure comprises: window synchronization, frequency estimation, Discrete Fourier Transform (DFT), channel estimation, phase noise estimation, etc. Also in this step S602, the constellation with high order modulation can be constructed.

In step S603, the constellation will be de-modulated by high order demodulation. Either likelihood or decided binary bit will be sending out. According to another example of the invention, the high order modulation uses M-ray phase shift keying (M-PSK) or M-ray quadrature amplitude modulation (M-QAM), M≧8, but the high order modulation of the invention is not limited to this, and other high order modulation which is existing or to be developed in the future can be applied to the invention. Thus, the high order demodulation at the receiving side corresponds to the high order modulation at the transmitting side.

In step S604, the advanced decoding step will compute and recover the signal using some decoding algorithms corresponding to the advanced coding step, such as log-domain sum-product algorithm. If the binary bit is decided in this step, then the inner hard-decision scheme is used in the inner advanced decoding step. If the likelihood is sent, then the inner decoding step will use soft-decision scheme, which has further improvement compared to hard-decision scheme. According to one example of the invention, the advanced coding has a coding gain above 7 dB at a bit error rate of 10⁻¹³ compared to BER-versus-OSNR performance of un-coded transmission. According to another example of the invention, the advanced coding has a code rate R of 20%˜75%. The advanced coding may use a strong error correction code, such as Low-density parity-check code, Turbo code, and so on, but the invention is not limited to this, and other advanced coding methods which are existing or to be developed in the future can be applied to this invention. Thus, the advanced decoding at the receiving side corresponds to the advanced coding at the transmitting side.

According to another example of the invention, if at the transmitting side, the signal was interleaved and encoded before the advanced coding step, the method 600 at the receiving side further comprises the steps of: after the advanced decoding step: de-interleaving the decoded signal; and decoding the de-interleaved signal.

Thus, according to the invention, the corrupted LO subcarrier information can be fully recovered, while the bandwidth of the transmitted signal may be substantially the same as the existing optical OFDM system, and there is no need to add any feedback control module or feedback loop support or the like to the existing optical OFDM system, so that the complexity of the receiving side can be reduced.

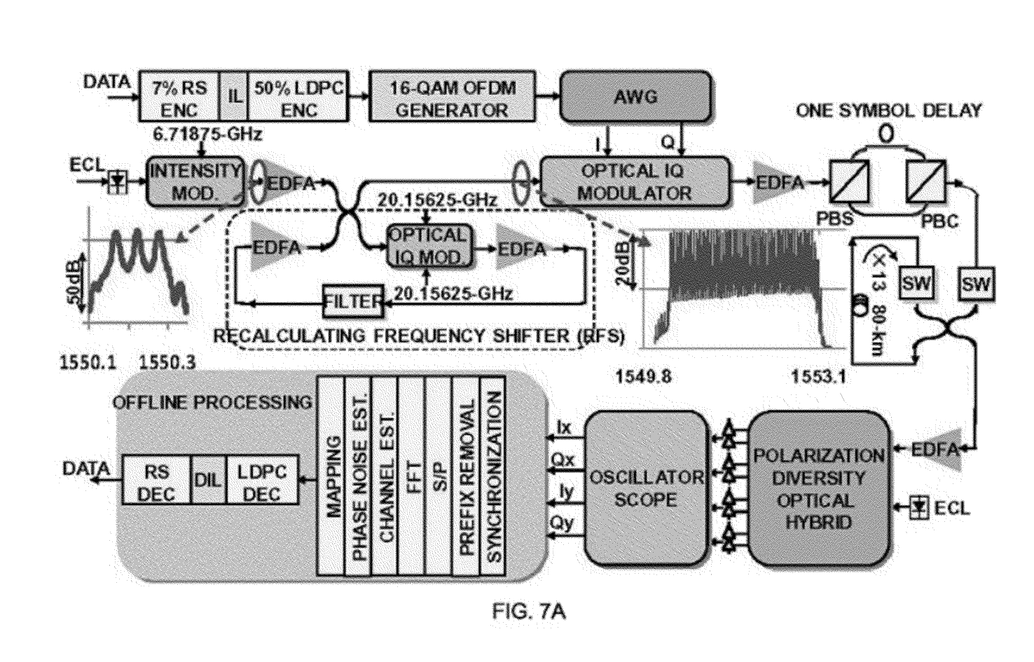

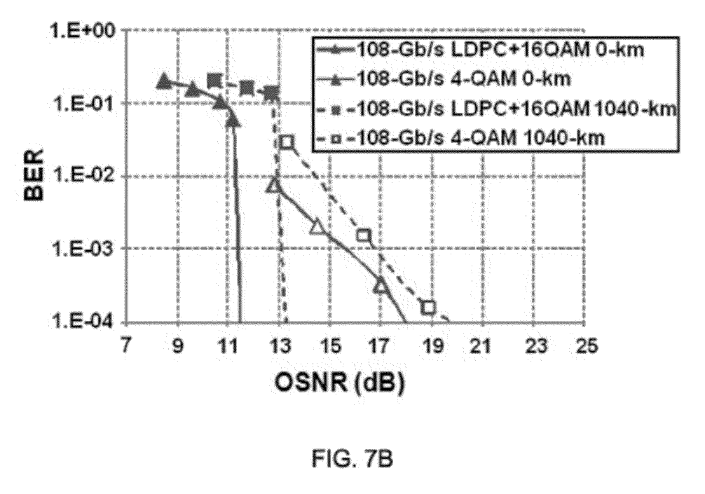

An experimental demonstration is shown here for instance. FIG. 7A shows the system configuration of 1.08-Tb/s coherent optical OFDM over 1040-km transmission. The signal laser is first spit into 50 tones. Each tone is carrying 21.6-Gb/s signal. Here 5 tones are used to compare the 100-Gb/s performance.

FIG. 7B is a diagram for showing the performances of the conventional system and the inventive system of FIG. 7A. In FIG. 7B, the horizontal axis indicates Optical Signal Noise Ratio (OSNR), while the vertical axis indicates Bit Error Rate (BER). The system is first transmitting 108-Gb/s signal using conventional 4-QAM scheme and 7% code rate FEC technique. Only five out of the 50 tones are used to transmit the 108-Gb/s signal. The conventional performance is shown in the solid curve in FIG. 7B. Then according to the invention, the system employs (15120, 7560) LDPC codes as advanced inner encoder/decoder (code rate is 50%). And the modulation format is changed to M=16. So the final net rate or spectrum efficiency or the bandwidth is the same as the conventional transmission which is using 4-QAM. Moreover, optionally, a (255,239) RS code is used as outer encoder/decoder. Optionally, interleaver and de-interleaver are inserted between outer and inner encoders/decoders respectively. The middle two subcarriers are null-filled, where the frequency of LO will be placed, so that no subcarrier will be corrupted in this case. The transmission performance using the advanced coding and higher order modulation according to the present invention is shown in the dashed curve in FIG. 7B. From the trend of 4-QAM curve and the (LDPC coded+16-QAM) curve, the LDPC can completely recover the noised signal with BER above 1×10⁻². But the conventional 7% FEC technique only can recover the signal with BER at 1×10⁻³. So the BER correction level is much improved under the same system configuration. The FFT size is 128 in the demonstration. If one subcarrier is corrupted by the LO, then the BER will be about 7.8×10⁻³. Comparing this BER level with the conventional 7% FEC and the inventive scheme with LDPC (advanced coding) and 16-QAM (high order modulation), if all the subcarriers are used, i.e., there is no null-filled subscriber, and LO is beating with any used subcarrier, only the inventive scheme can recover the signal including the corrupted LO subcarrier.

Thus, according to the invention, the corrupted LO subcarrier information can be fully recovered, while the bandwidth of the transmitted signal may be substantially the same as the conventional optical OFDM system.

It should be understood by the person skilled in the art, the coherent optical OFDM system is considered as an example in the disclosure, but the invention can be applied to any other OFDM communication system, or other optical communication system or even other electrical communication system.

While example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

The embodiments of the invention have been described with reference to the drawings above, however, the invention is not limited to the disclosed embodiments and drawings. It should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

With only some example embodiments of the present invention having thus been described, it will be obvious that the same may be varied in many ways. The description of the invention hereinbefore uses these examples, including the best mode, to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Such variations are not to be regarded as a departure from the spirit and scope of the present invention, and all such modifications are intended to be included within the scope of the present invention as stated in the following claims. What is claimed is:

1. A method for converting a data signal into an optical OFDM signal, comprising:
performing advanced coding on a data signal to obtain an encoded signal;
performing high order modulation on the encoded signal to obtain a high-order-modulated signal;
performing OFDM modulation on the high-order-modulated signal to obtain an electrical OFDM signal; and
performing up-conversion on the electrical OFDM signal to obtain an optical OFDM signal to be output.

2. The method according to claim 1, wherein, the advanced coding has a coding gain above 7 dB at a bit error rate of 10⁻¹³ compared to BER-versus-OSNR performance of un-coded transmission.

3. The method according to claim 1, wherein, the advanced coding has a code rate of 20%˜75%.

4. The method according to claim 1, wherein, the advanced coding includes one of Low-density parity-check coding, and Turbo coding.

5. The method according to claim 1, wherein, the high order modulation uses M-ray phase shift keying (M-PSK) or M-ray quadrature amplitude modulation (M-QAM), M≧8.

6. The method according to claim 1, prior to the advanced coding step, further comprising:
encoding input bits; and
interleaving the encoded bits to obtain the data signal on which the advanced coding is to be performed.

7. The method according to claim 1, wherein, the electrical OFDM signal comprises a plurality of subcarriers.

8. A method for converting an optical OFDM signal on which advanced coding, high order modulation, OFDM modulation, and up-conversion were performed, into a data signal, the method comprising the steps of:
performing down-conversion on the optical OFDM signal to obtain an electrical OFDM signal;
performing OFDM demodulation on the electrical OFDM signal;
performing high order demodulation on the OFDM-demodulated signal; and
performing advanced decoding on the high-order-de-modulated signal to obtain a data signal.

9. The method according to claim 8, wherein, the advanced coding has a coding gain above 7 dB at a bit error rate of 10⁻¹³ compared to BER-versus-OSNR performance of un-coded transmission.

10. The method according to claim 8, wherein, the advanced coding has a code rate of 20%˜75%.

11. The method according to claim 8, wherein, the advanced coding includes one of Low-density parity-check coding, and Turbo coding.

12. The method according to claim 8, wherein, the high order modulation uses M-ray phase shift keying (M-PSK) or M-ray quadrature amplitude modulation (M-QAM), M≧8.

13. The method according to claim 8, further comprising the steps of:
after the advanced decoding step:
de-interleaving the decoded signal; and
decoding the de-interleaved signal.

14. The method according to claim 8, wherein, the electrical OFDM signal comprises a plurality of subcarriers.

15. A converter for converting a data signal into an optical OFDM signal, comprising
an advanced encoder for performing advanced coding on a data signal to obtain an encoded signal;
a high order modulator for performing high order modulation on the encoded signal to obtain a high-order-modulated signal;
an OFDM modulator for performing OFDM modulation on the high-order-modulated signal to obtain an electrical OFDM signal; and
an up-converter for performing up-conversion on the electrical OFDM signal to obtain an optical OFDM signal to be output.

16. The converter according to claim 15, wherein, the advanced encoder has a coding gain above 7 dB at a bit error rate of 10⁻¹³ compared to BER-versus-OSNR performance of un-coded transmission.

17. The converter according to claim 15, wherein, the advanced encoder has a code rate of 20%˜75%.

18. The converter according to claim 15, wherein, the advanced encoder uses one of Low-density parity-check coding, and Turbo coding.

19. The converter according to claim 15, wherein, the high order modulator uses M-ray phase shift keying (M-PSK) or M-ray quadrature amplitude modulation (M-QAM), M≧8.

20. The converter according to claim 15, further comprising:
an outer encoder for encoding input bits; and
an interleaver for interleaving the encoded bits to obtain the data signal on which the advanced coding is to be performed by the advanced encoder.

21. The converter according to claim 15, wherein, the electrical OFDM signal comprises a plurality of subcarriers.

22. A converter for converting an optical OFDM signal on which advanced coding, high order modulation, OFDM modulation, and up-conversion were performed, into a data signal, the converter comprising:
an down-converter for performing down-conversion on the optical OFDM signal to obtain an electrical OFDM signal;
an OFDM demodulator for performing OFDM demodulation on the electrical OFDM signal;
a high order demodulator for performing high order demodulation on the OFDM-demodulated signal; and
an advanced decoder for performing advanced decoding on the high-order-de-modulated signal to obtain a data signal.

23. The converter according to claim 22, wherein, the advanced encoder has a coding gain above 7 dB at a bit error rate of 10⁻¹³ compared to BER-versus-OSNR performance of un-coded transmission.

24. The converter according to claim 22, wherein, the advanced encoder has a code rate of 20%˜75%.

25. The converter according to claim 22, wherein, the advanced encoder uses one of Low-density parity-check coding, and Turbo coding.

26. The converter according to claim 22, wherein, the high order modulator uses M-ray phase shift keying (M-PSK) or M-ray quadrature amplitude modulation (M-QAM), M≧8.

27. The converter according to claim 22, further comprising:
a de-interleaver for de-interleaving the data signal; and
an outer decoder for decoding the de-interleaved signal.

28. The converter according to claim 22, wherein, the electrical OFDM signal comprises a plurality of subcarriers.

29. A transmitting device for transmitting an optical OFDM signal, comprising:
an advanced encoder for performing advanced coding on a data signal to obtain an encoded signal;
a high order modulator for performing high order modulation on the encoded signal to obtain a high-order-modulated signal;
an OFDM modulator for performing OFDM modulation on the high-order-modulated signal to obtain an electrical OFDM signal;
an up-converter for performing up-conversion on the electrical OFDM signal to obtain an optical OFDM signal to be output; and
a transmitting unit for transmitting the optical OFDM signal.

30. A receiving device for receiving an optical OFDM signal on which advanced coding, high order modulation, OFDM modulation, and up-conversion were performed, the receiving device comprising:
a receiving unit for receiving the optical OFDM signal;
an down-converter for performing down-conversion on the optical OFDM signal to obtain an electrical OFDM signal;
an OFDM demodulator for performing OFDM demodulation on the electrical OFDM signal;
a high order demodulator for performing high order demodulation on the OFDM-demodulated signal; and
an advanced decoder for performing advanced decoding on the high-order-de-modulated signal to obtain a data signal.

31. An optical communication system, comprising:
a transmitting device including
an advanced encoder for performing advanced coding on a data signal to obtain an encoded signal;
a high order modulator for performing high order modulation on the encoded signal to obtain a high-order-modulated signal;
an OFDM modulator for performing OFDM modulation on the high-order-modulated signal to obtain an electrical OFDM signal;
an up-converter for performing up-conversion on the electrical OFDM signal to obtain an optical OFDM signal to be output; and
a transmitting unit for transmitting the optical OFDM signal;
a receiving device for communicating with the transmitting device including
a receiving unit for receiving the optical OFDM signal;
an down-converter for performing down-conversion on the optical OFDM signal to obtain an electrical OFDM signal;
an OFDM demodulator for performing OFDM demodulation on the electrical OFDM signal;
a high order demodulator for performing high order demodulation on the OFDM-demodulated signal; and
an advanced decoder for performing advanced decoding on the high-order-de-modulated signal to obtain a data signal.

32. The system according to claim 31, wherein, the advanced encoder has a coding gain above 7 dB at a bit error rate of 10⁻¹³ compared to BER-versus-OSNR performance of un-coded transmission.

33. The system according to claim 31, wherein, the advanced encoder has a code rate of 20%˜75%.

34. The system according to claim 31, wherein, the advanced encoder uses one of Low-density parity-check coding, and Turbo coding.

35. The system according to claim 31, wherein, the high order modulator uses M-ray phase shift keying (M-PSK) or M-ray quadrature amplitude modulation (M-QAM), M≧8.

36. The system according to claim 31, further comprising:
an outer encoder for encoding input bits;
an interleaver for interleaving the encoded bits to obtain the data signal on which advanced coding is to be performed by the advanced encoder;
a de-interleaver for de-interleaving the decoded signal by the advanced decoder; and
an outer decoder for decoding the de-interleaved signal.

37. The system according to claim 31, wherein the electrical OFDM signal comprises a plurality of subcarriers.
